(19) United States
(12) Patent Application Publication
(10) Pub. No.: US 2006/0175482 A1
(43) Pub. Date: Aug. 10, 2006

(54) Tripod head

(76) Inventor: Joseph Johnson, Los Osos, CA (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/326,980

(22) Filed: Jan. 5, 2006

Related U.S. Application Data
(60) Provisional application No. 60/642,074, filed on Jan. 6, 2005.

(51) Int. Cl. F16M 11/00

(52) U.S. Cl. 248/176.1

(57) ABSTRACT

A tripod head having a low profile and efficient interaction for the user to operate. The tripod head may include a set of knobs and a panning base. The panning base may be adjustable in its positioning and may have a locking mechanism.

### CROSS-REFERENCE To RELATED APPLICATIONS

This application claims the benefit of U.S. Provisional App. No. 60/642,074, filed Jan. 6, 2005.

### BACKGROUND OF THE INVENTION

The present invention relates to a tripod head.

A tripod head is suitable for supporting an optical instrument, such as a film camera or a video camera. Typically, the tripod head includes a generally cylindrical housing, which has a connection mechanism at one end for a tripod. A ball member in the housing is movably engaged and is provided with a locking device at one end thereof for supporting the optical instrument.

In the tripod head of this type, the ball member is generally a spherical ball having an extension for connecting of to a locking device, and the locking device normally consists essentially of a split clamp having a recess adapted to mate with a plate attached to the optical instrument, and a clamping screw for securing the ball in place in the housing.

### BRIEF DESCRIPTION OF THE SEVERAL VIEWS OF THE DRAWINGS

FIG. 1 is a pictorial view of a ball head.

FIG. 2 illustrates a rear view of the ball head of FIG. 1.

FIG. 3 illustrates a front view of the ball head of FIG. 1.

FIG. 4 illustrates a left side view of the ball head of FIG. 1.

FIG. 5 illustrates a right side view of the ball head of FIG. 1.

FIG. 6 illustrates a top view of the ball head of FIG. 1.

FIG. 7 illustrates a pictorial view of the ball head of FIG. 1 without a clamp.

FIG. 8 illustrates a ball head assembly drawing.

FIG. 9 illustrates a body for the ball head.

FIG. 10 illustrates a ball for the ball head.

FIG. 11 illustrates a bearing for the ball head.

FIG. 12 illustrates sectional views of the bearing of FIG. 11.

FIG. 13 illustrates a ball knob for the ball head.

FIG. 14 illustrates a stud for the ball head.

FIG. 15 illustrates a friction knob for the ball head.

FIG. 16 illustrates a gasket for the ball head.

FIG. 17 illustrates a pan know for the ball head.

FIG. 18 illustrates a pan base for the ball head.

FIG. 19 illustrates a threaded insert for the ball head.

FIG. 20 illustrates a pan base bearing for the ball head.

FIG. 21 illustrates an outer ring pan base for the ball head.

FIG. 22 illustrates a timing pin for the ball head.

FIG. 23 illustrates an inner ring pan base for the ball head.

FIG. 24 illustrates a clamp for the ball head.

FIGS. 25A-25F illustrates views of the body for the ball head.

FIG. 26 illustrates an assembly drawing for the ball head.

FIG. 27 illustrates another assembly drawing for the ball head.

### DETAILED DESCRIPTION OF PREFERRED EMBODIMENT

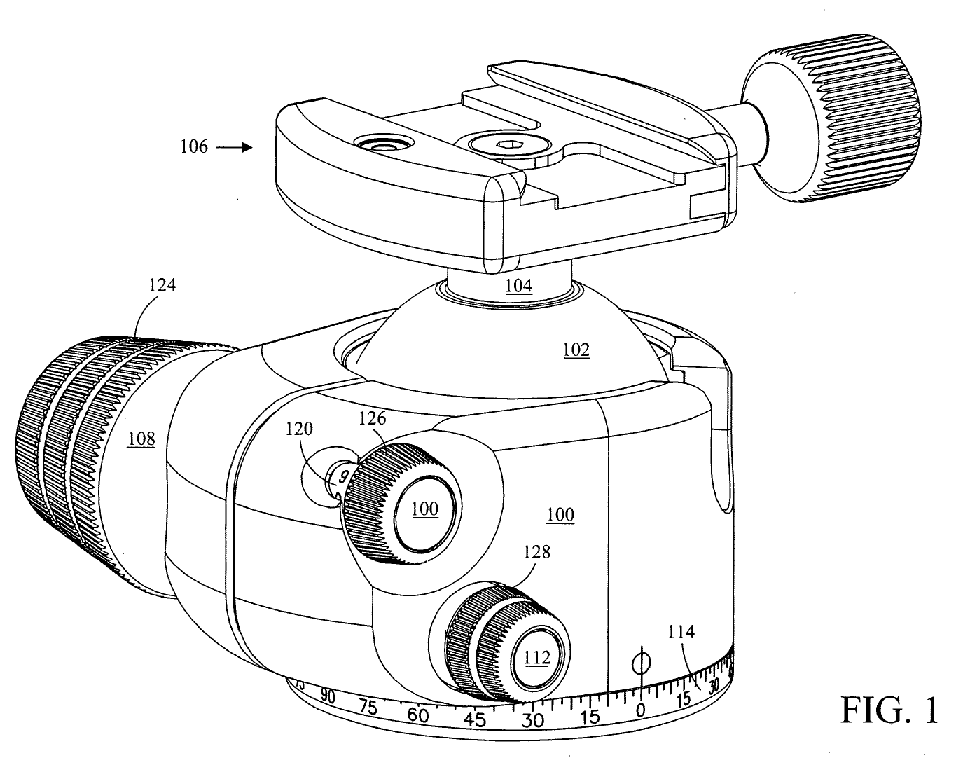

Referring to FIG. 1 a tripod head includes a body 100 and a ball 102. The body 100 may have any suitable configuration and the ball 102 may be spherical, elliptical, or otherwise any other suitable shape. The ball 102 may include a stem 104 to which is attached a clamp 106. In many cases, the optical instrument includes a plate attached to the lower portion thereof. The plate it sized such that it is detachably engaged with the clamp 106, which selectively secures the plate. In some cases, the stem 104 includes a threaded opening therein or a threaded screw, which is detachably attached to the optical instrument. A ball knob 108, when turned clockwise, causes the ball 102 to be engaged and held in place, and hence inhibit the ball 102 from being rotated. The ball knob 108, when turned counter-clockwise causes the ball 102 to be disengaged, and hence readily permit the ball 102 to be rotated. A friction knob 110, when turned clockwise causes the ball 102 to be increasingly inhibited in its ability to move freely. The friction knob 110, when turned counter clockwise causes the ball 102 to be decreasingly inhibited in its ability to move freely. In operation, the friction knob 110 is primarily used to set a base friction on the ball 102 to inhibit its movement when the ball knob 108 is fully released by turning it counter clockwise. Then after positioning the optical instrument, such as a camera, the ball knob 108 is turned fully clockwise which increases the friction on the ball 102, normally sufficiently to maintain the optical instrument in position. A pan knob 112, when turned counter clockwise releases the body from a pan base 114, so that the body 100 may freely rotate in clockwise and counterclockwise directions. Then pan knob 114, when turned clockwise engages the body 100 with the pan base 114, so that the body 100 may not freely rotate in a clockwise and a counterclockwise direction.

The ball 102 is preferably spherical in shape, which are generally easier to manufacture and easier to assemble in the tripod head. In addition, the clamping mechanism on a spherical shaped ball 102 tends to be less likely to jam under adverse conditions, such as under cold conditions when the ball 102 tends to get sticky or when moisture tends to condense on the ball 102.

The ball knob 108, the friction knob 110, and the pan knob 112 are all partially recessed within a portion of the wall of the body 100. With a portion of the knobs 108, 110, and 112 terminating at a location partially with the body 100 then the knobs and any shafts attached thereto will have a significantly reduced likelihood of becoming snagged on a branch when the tripod head, attached to a tripod, is carried through a brushy region including smaller branches. For example, one test that may be used to determine if the knobs are properly situated with respect to the body 100 is to use a ¼ inch or ⅛th inch diameter flexible rod being dragged across the exterior of the body 100, and across the respective knob 108, 110, 112 (in one or both circular horizontal directions) in a manner similar to how a branch would drag across the exterior of the body 100. If the flexible rod does not get snagged in such a manner that the flexible rod must be moved backwards in order to continue over the respective knob 108, 110, 112, then the knobs are suitably recessed.

The friction knob 110 is supported on a shaft that includes a set of numerical numbers 120 written thereon that indicate the amount of friction. The numbers preferably go from 1 to 9, with a greater number indicating a greater friction. The numbers are also preferably located in a position at least partially within an opening in the body 100, which protects the numbers from being worn off during use. The friction knob 110 and the shaft are mechanically coupled in a direct relationship in such a manner that over time as the device wears, the numbers will still appear at the proper time. If the numbers were included on a separate member or a plastic insert around the shaft, then there is a higher likelihood that the separate member or insert will shift in a manner that the initial relationship between the numbers and the position of the friction knob 110 would change.

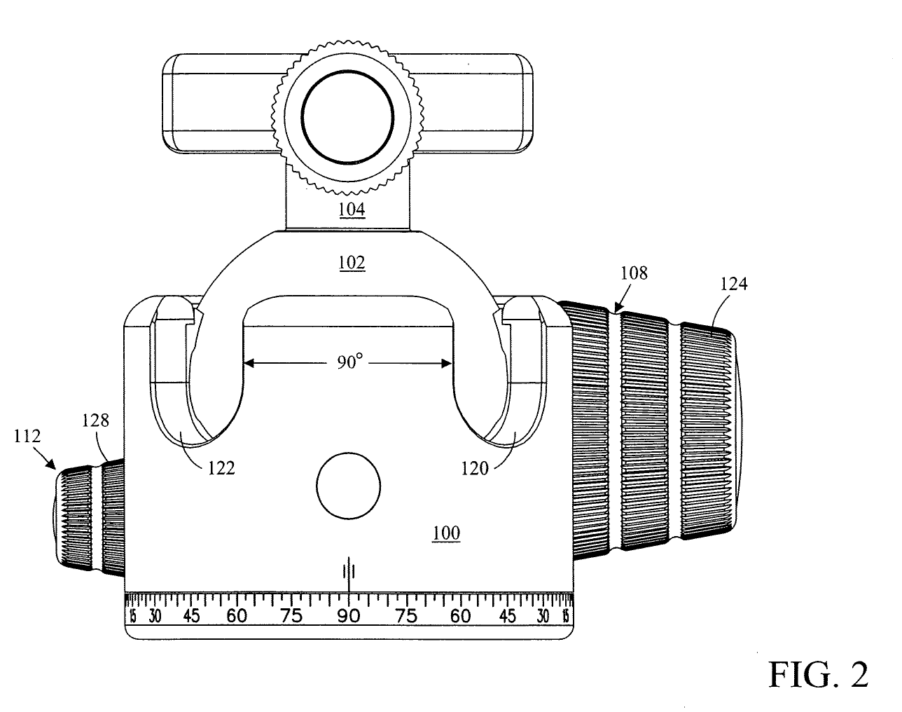

Referring to FIG. 2, the body 100 defines a pair of drop notches 120 and 122. The ball 102 may be rotated such that the stem 104 ends up resting in either one of the drop notches 120 and 122. It is desirable to be able to move the stem 104 into a drop notch for changing the horizontal/vertical orientation of the camera (especially suitable for non-square film, such as 35 mm film) and for pointing the camera toward the ground with a minimal amount of camera rotation. In order to accommodate such movements, it was determined that a 90 degree spacing (or substantially 90 degrees) between the drop notches 120 and 122 are preferable. The spacing may likewise be between 80 and 100 degrees, if desired.

The ball knob 108 preferably has a diameter at its base that is greater than 75% of the height of the body 100. In this manner, the ball knob 108 is sufficiently large that photographers with gloves working in a cold environment are able to effectively operate the most important knob of the ball head. The threads 124, 126, 128 on the respective knobs 108, 110, 112 permit a more positive grip on the knobs.

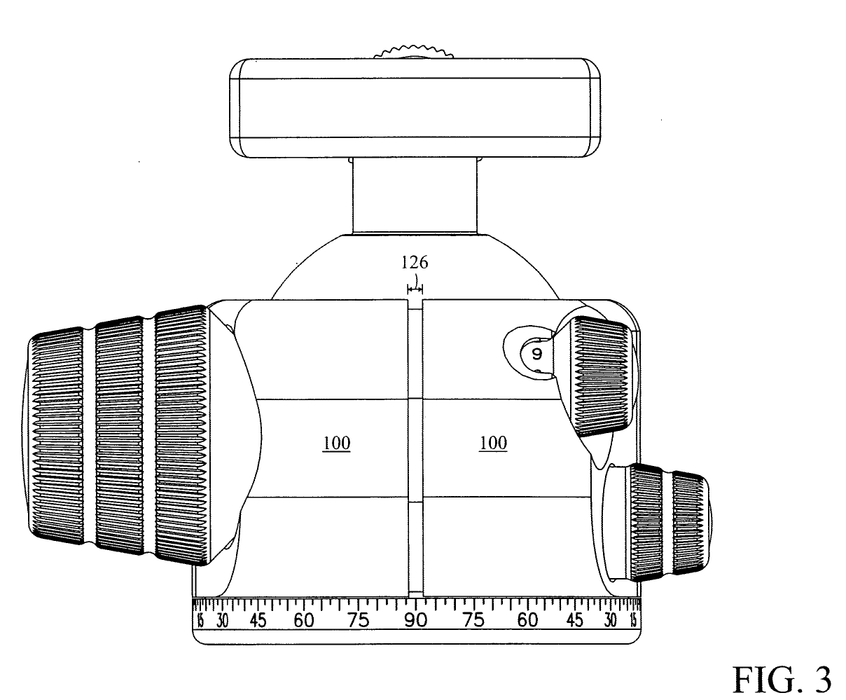

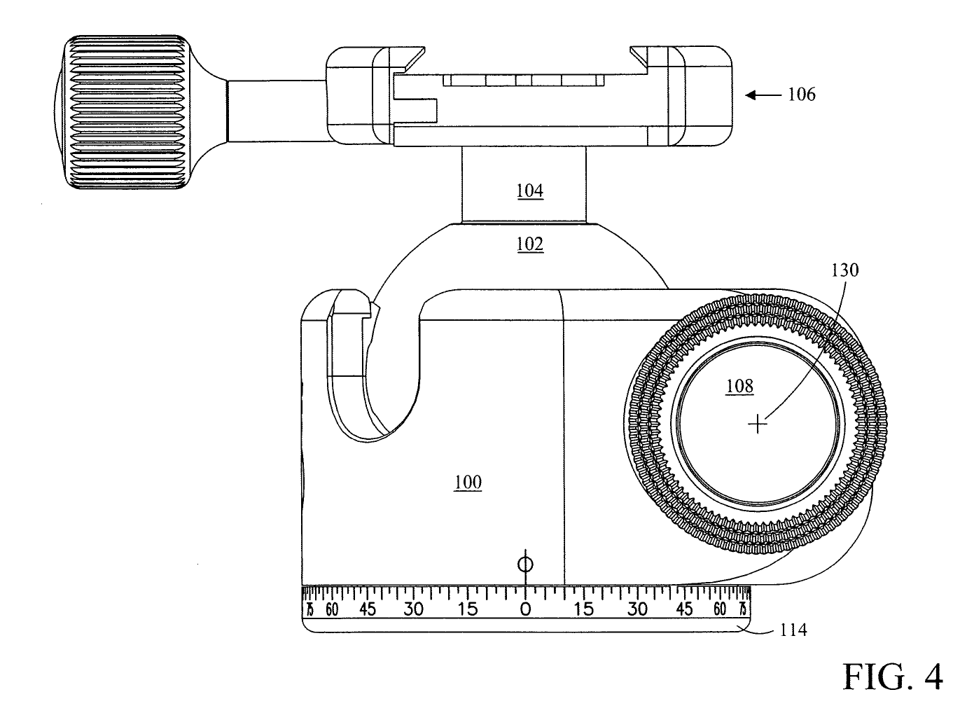

Referring to FIG. 3, the body 100 preferably defines one and only one slit 126 therein. By using a single slit 126 in the body 100, as opposed to multiple slits in the body, a more controlled squeezing action of the ball 102 may be performed. In addition, it limits the complexity of the device, which increases reliability. In addition, the ball knob 108 preferably goes from fully released to fully engaged in less than a single turn. By permitting the engagement and disengagement within a single turn facilitates quick and efficient locking of the ball 102 in place before the optical instrument moves. In addition, this increases the likelihood that the user will be able to go from unlocked to locked without having to remove his hand from the ball knob 108, thus performing the operation in a single twist of his wrist.

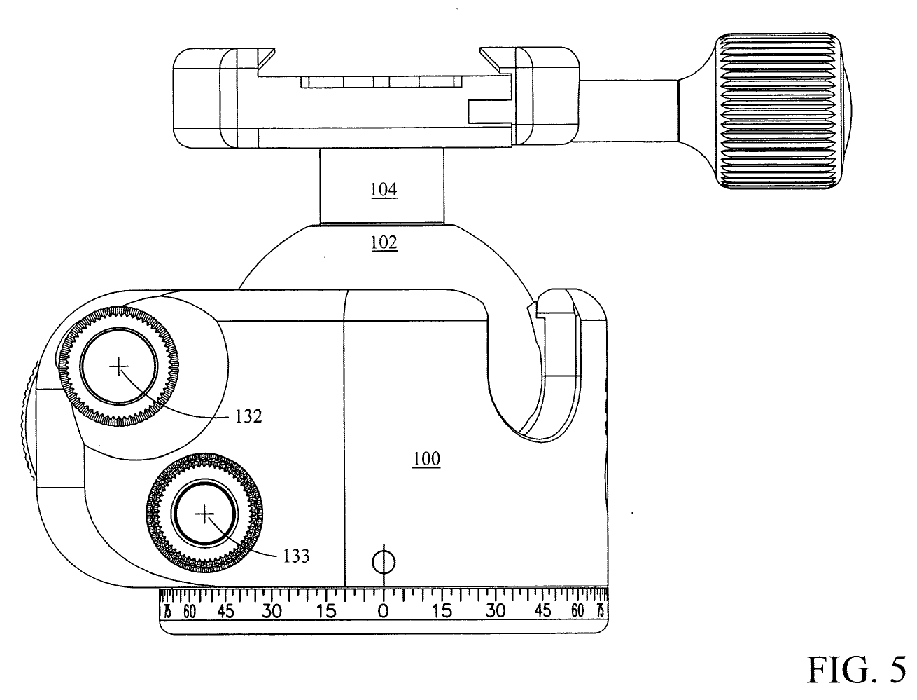

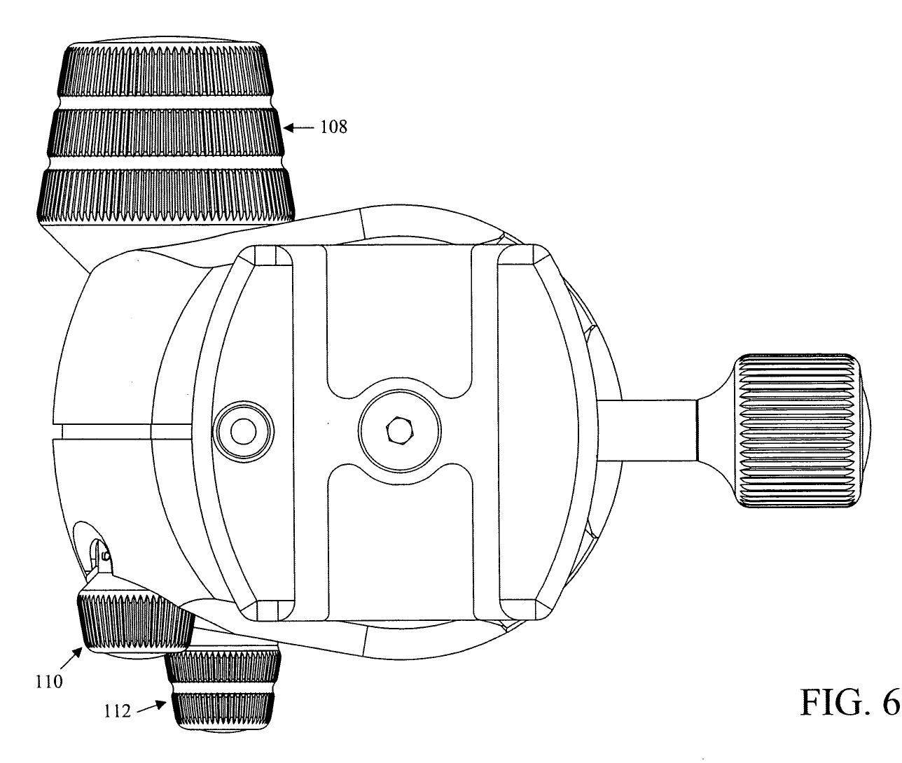

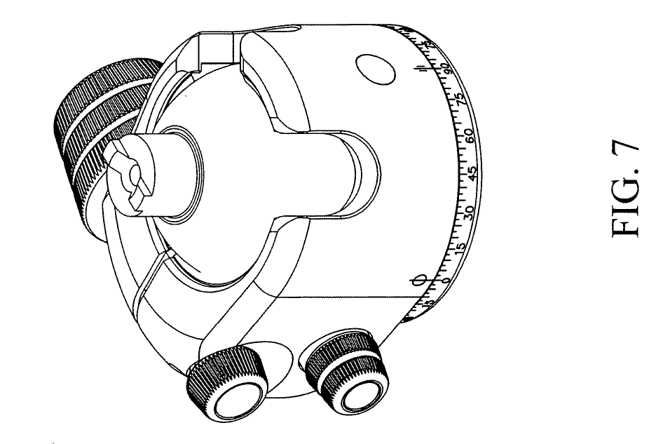

Referring to FIGS. 4 and 5, the ball knob and the friction knob each have an axis of rotation 130 and 132 that is offset past the outer circumference of the pan base 114. By locating the axis 130, 132 offset past the pan base 114 a significant part of the mechanism for operation of the ball head is shifted to the side of the ball head thus permitting less operational mechanisms for the operation of the ball head to be directly above the pan base 114. With less operational materials directly above the pan base 114, the top of the ball 102 may be lower than it would otherwise be, thus decreasing the overall height of the tripod head. A shorter ball head reduces the amount of movement of the optical equipment as a result of vibration within the tripod. Referring to FIG. 6, it is also desirable to include the ball knob 108 in a position opposing the friction knob 110 and panning knob 108. In this manner, the friction knob 110 and panning knob 108 are not likely to be inadvertently moved when turning the ball knob 108 on a consistent basis. The axis of the ball knob 108 and the panning knob 108/friction knob 110 (axis 133) are preferably within 30 degrees of each other. In addition, the axis of said panning knob 108 and said friction knob 110 are preferably within 30 degrees of one another and more preferably parallel to one another. Referring to FIG. 7, the ball head without a clamp 106 attached thereto is illustrated.

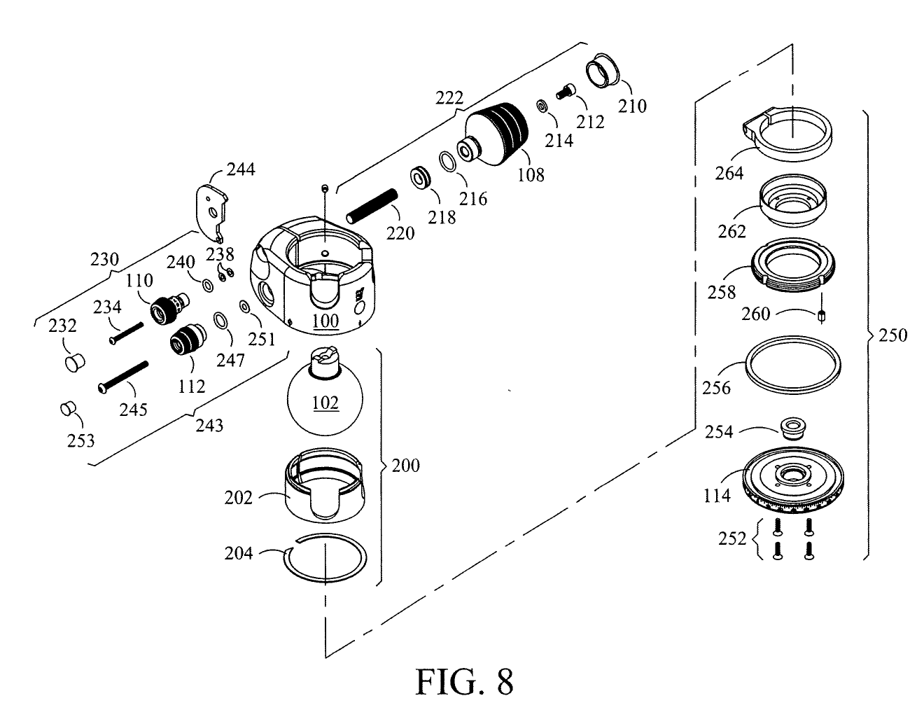

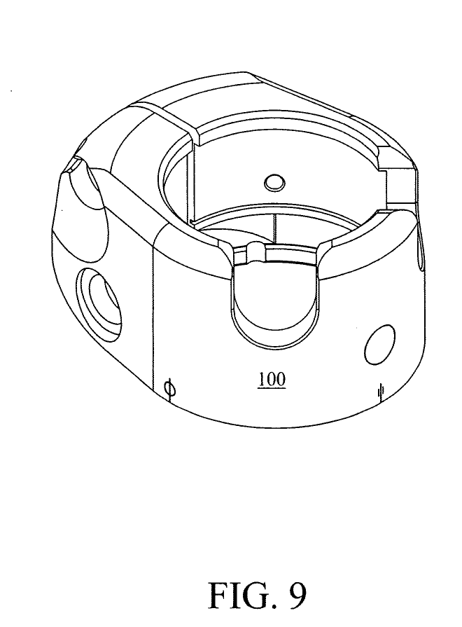

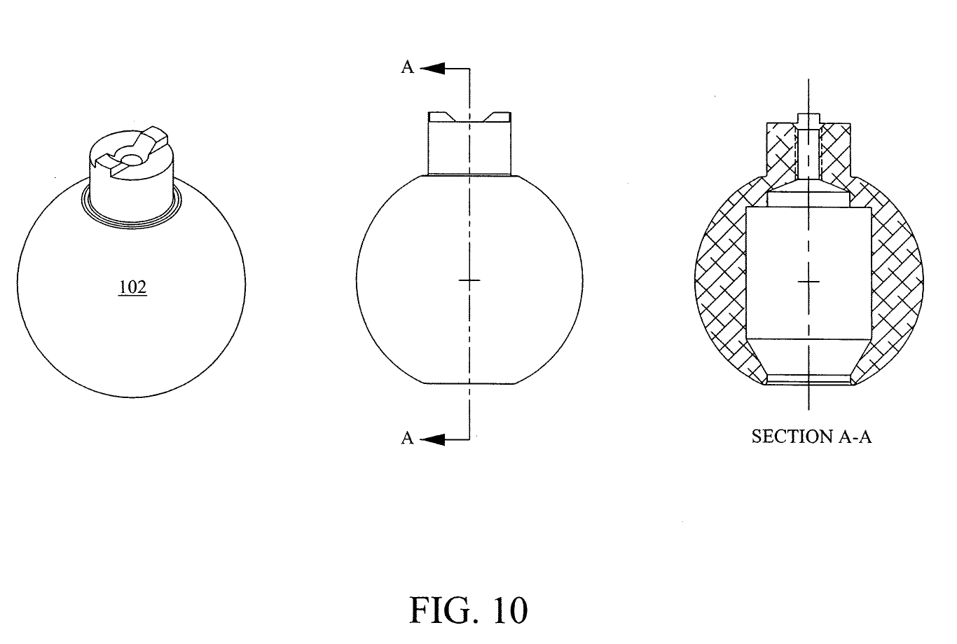

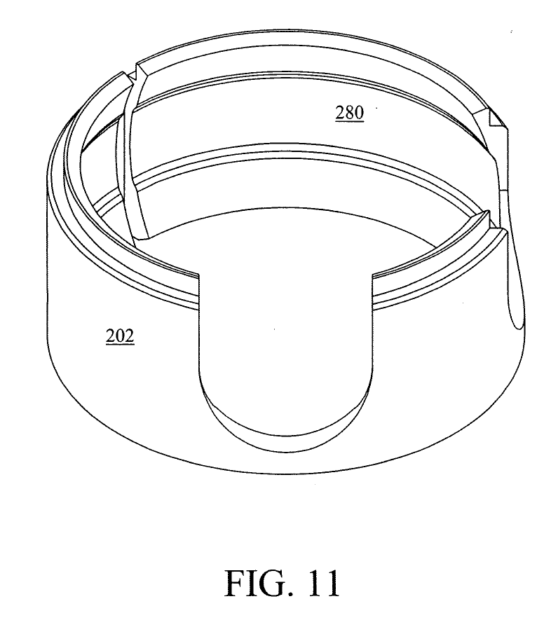

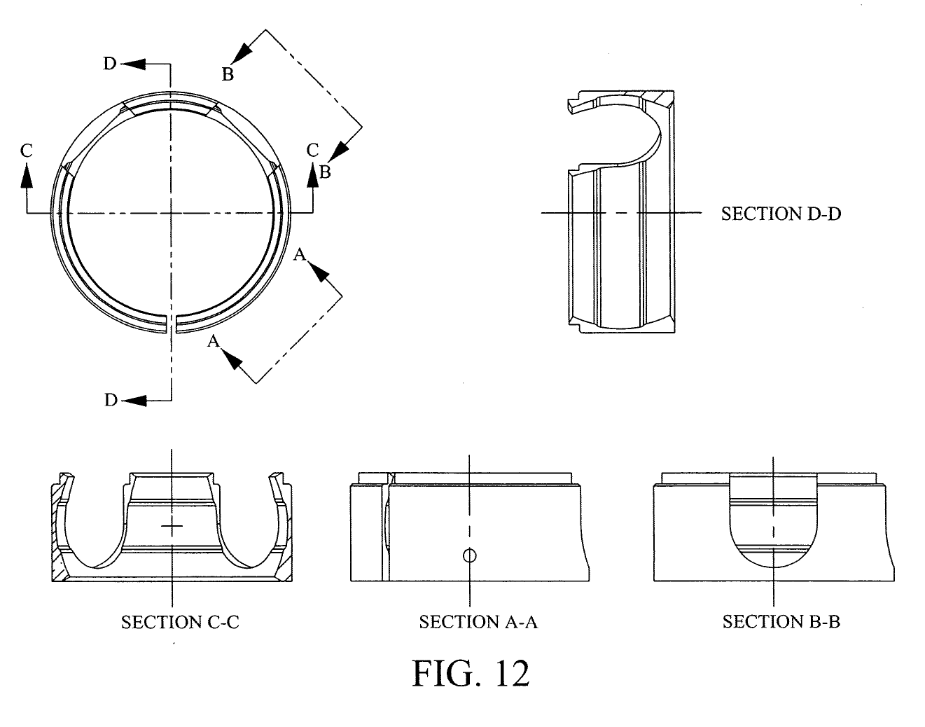

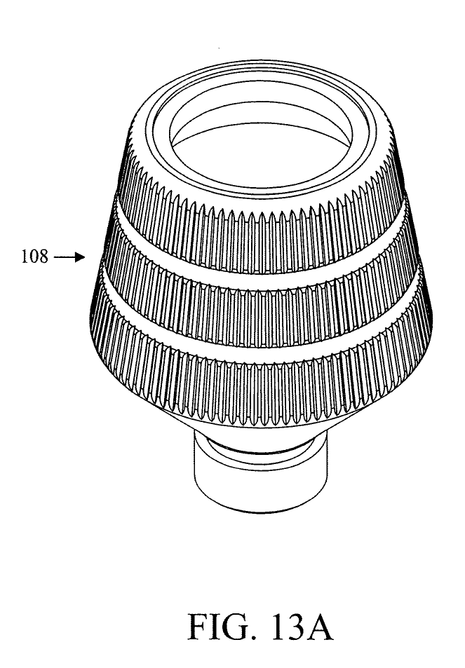

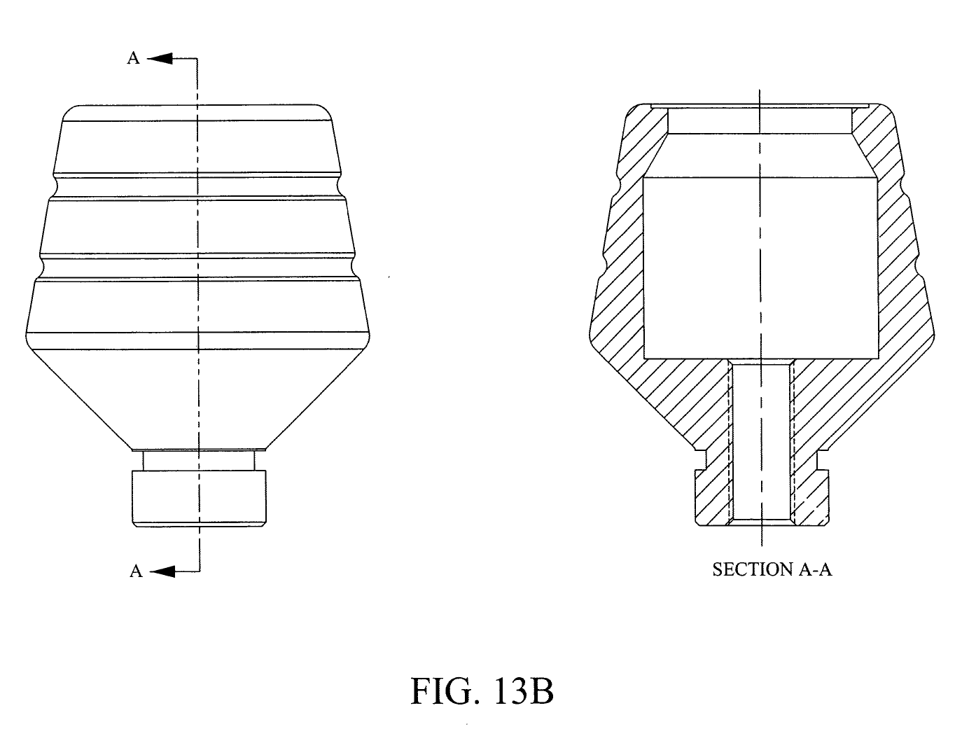

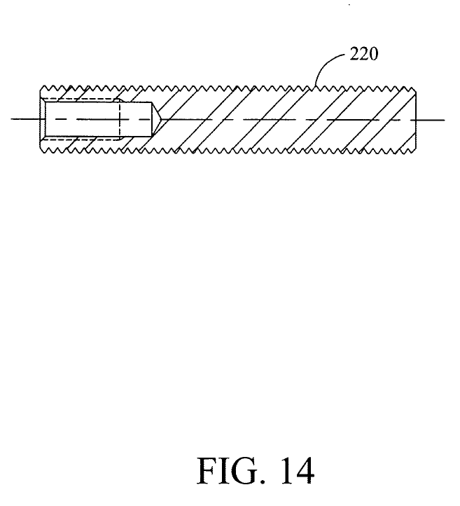

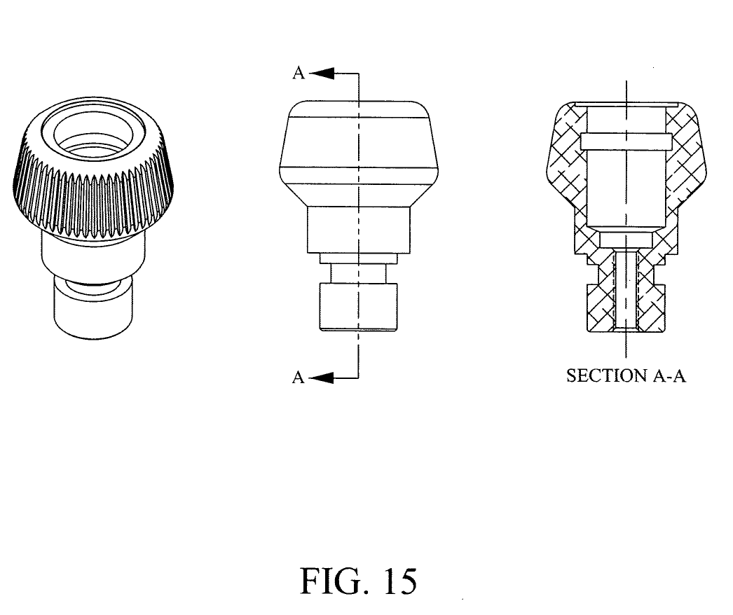

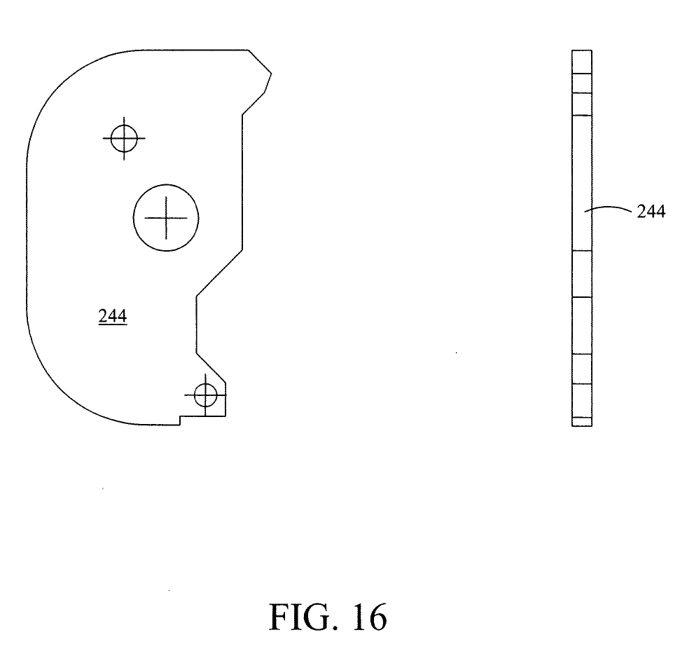

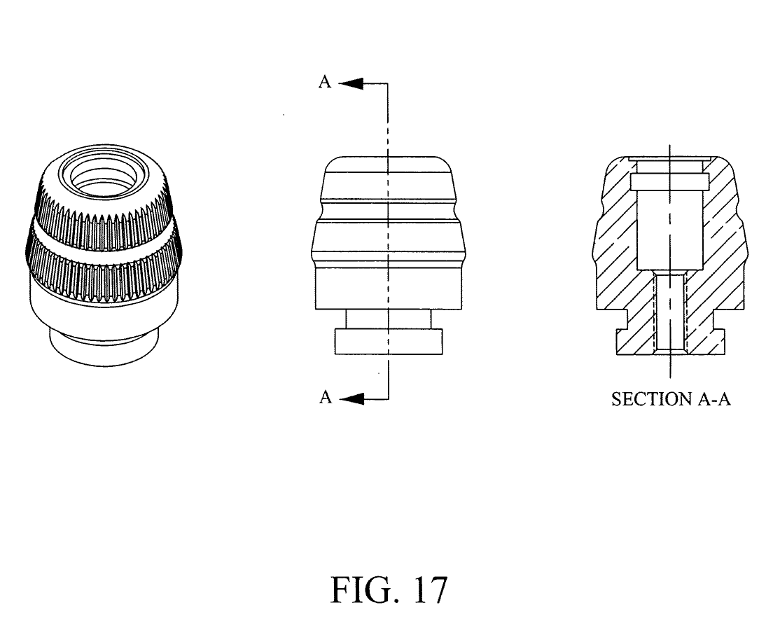

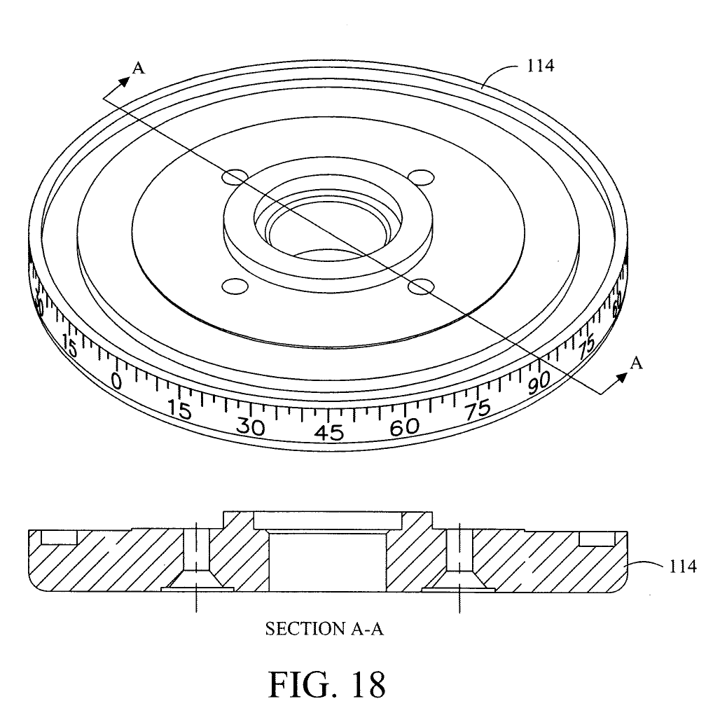

Referring to FIG. 8, the body assembly 200 may be constructed with the body 100 (see FIG. 9), the ball 102 (see FIG. 10) which rests in a resilient bearing 202 (see FIGS. 11 and 12) and a retaining ring 204. The ball knob assembly 222 includes a screw 212, washer 214, ball knob 108 (see FIG. 13), o-ring 216, bearing 218, and stud 220 (see FIG. 14). A plug 210 covers the screw 212. The friction knob assembly 230 includes a screw 234, a friction knob 108 (see FIG. 15), an o-ring 238, and a pair of belleville washers 240. A resilient gasket 244 (see FIG. 16) is located at least partially within the slit 126 defined by the body 100. The use of the gasket 244 reduces the likelihood that debris and other materials will get between the ball 102 and the body 100, thereby reducing the ease of operation of the tripod head. The pan knob assembly 243 includes a screw 245, a pan knob 112 (see FIG. 17), an o-ring 247, a washer 251, and a plug 253.

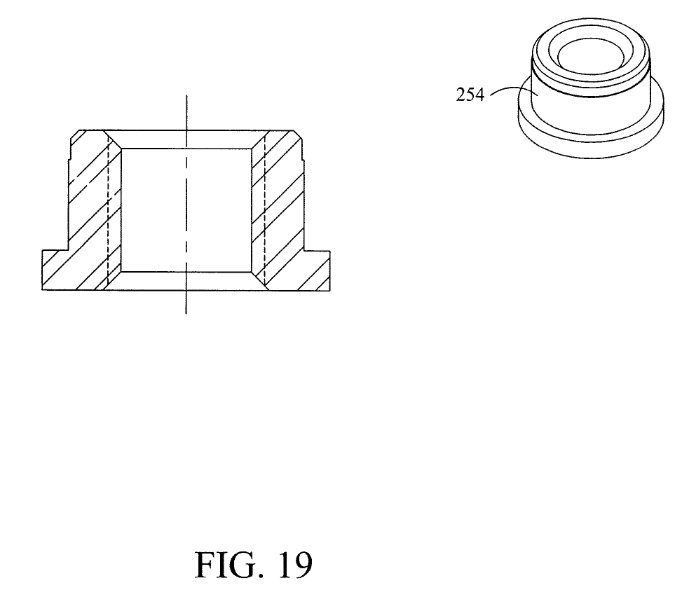

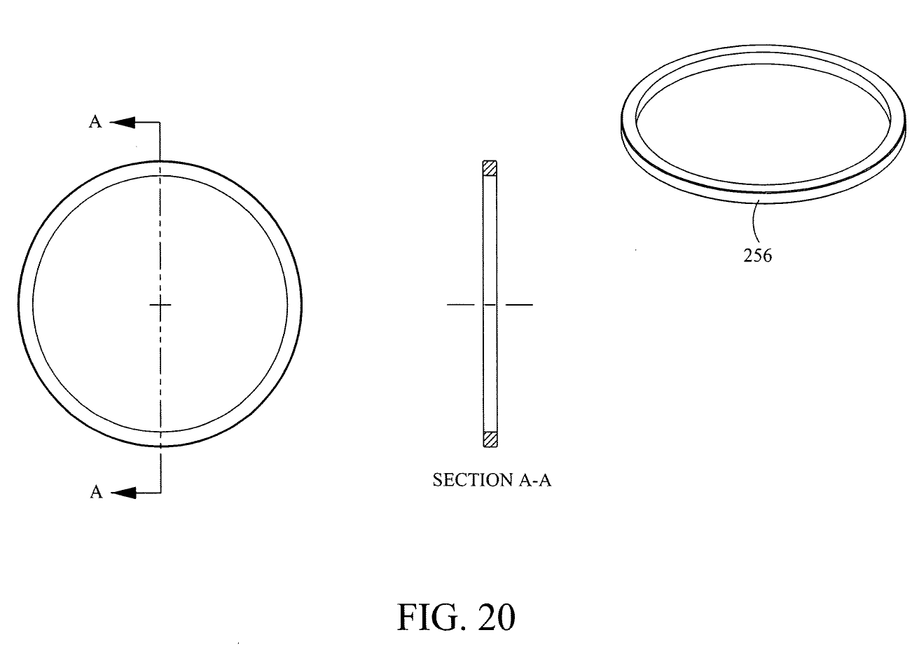

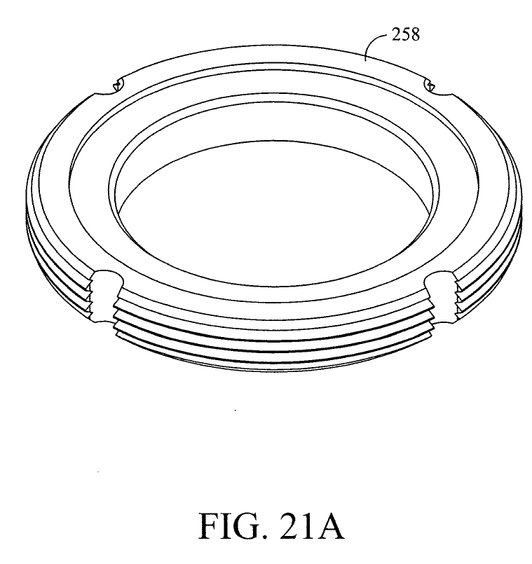

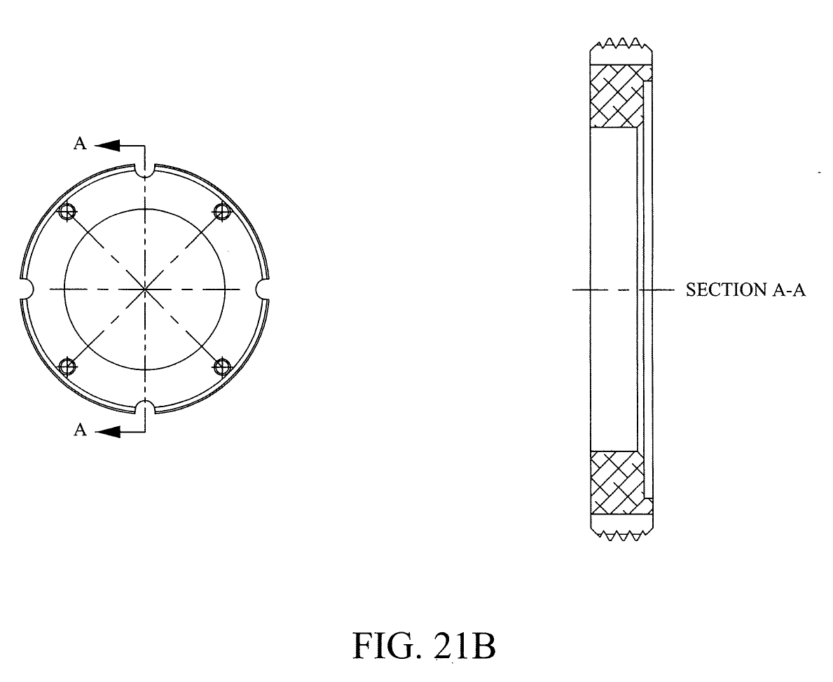

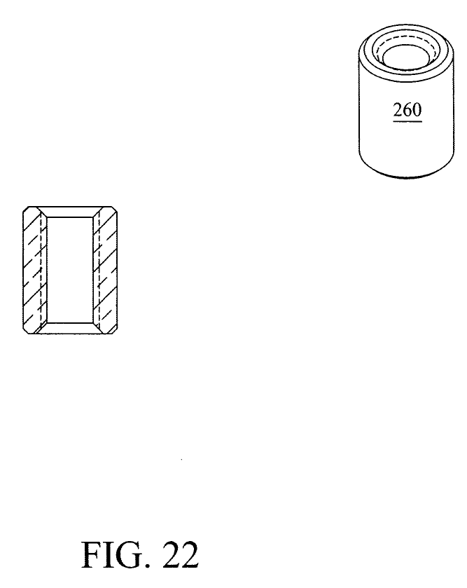

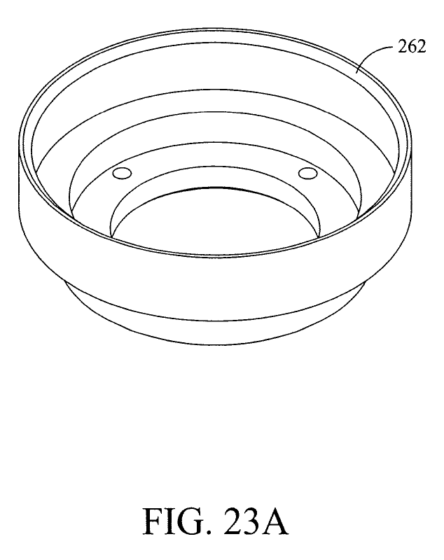

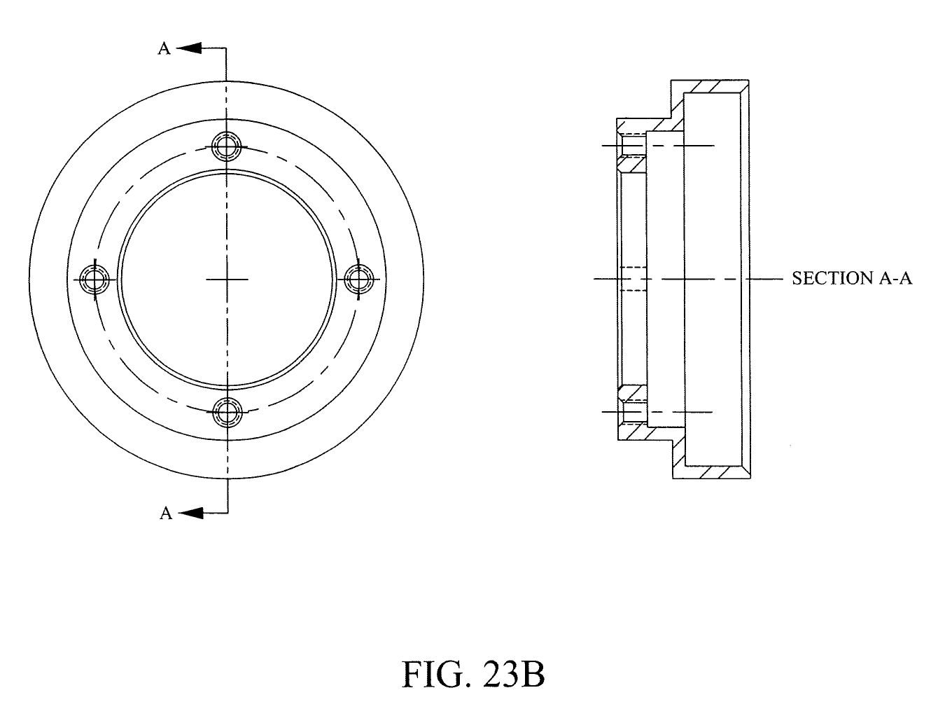

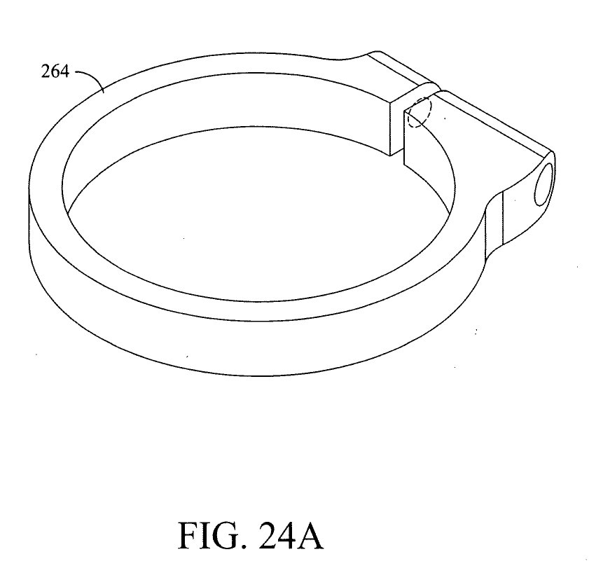

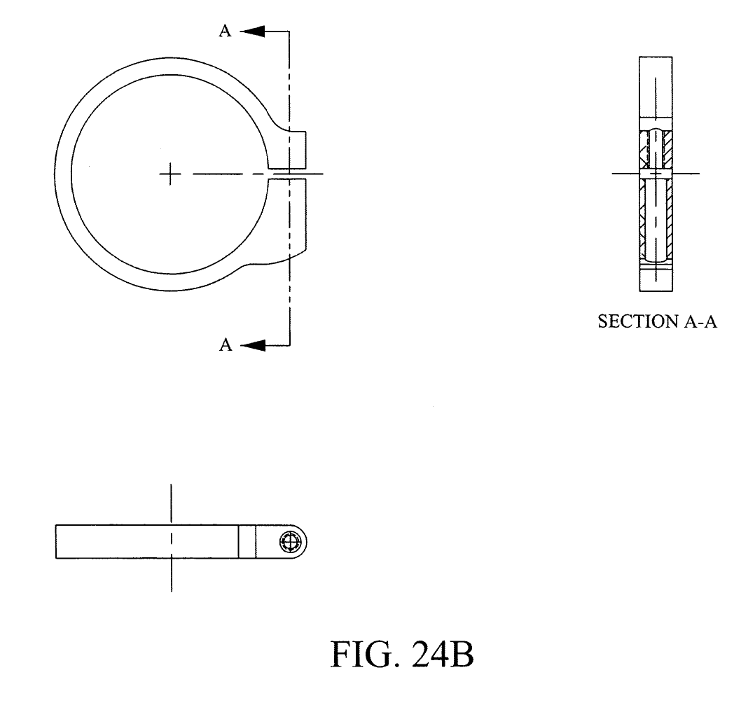

The pan base assembly 250 includes a set of screws 252, a pan base 114 (see FIG. 18), a threaded insert 254 (see FIG. 19), a pan base bearing 256 (see FIG. 20), a pan base outer ring 258 (see FIG. 21), a timing pin 260 (see FIG. 22), a pan base inner ring 262 (see FIG. 23), and a clamp 264 (see FIG. 24). The pan base outer ring 258 is threaded so that it matingly engages with the lower threaded portion of the base 100. The outer ring 258 is threaded into the base 100 a sufficient distance so that the pan base 114 is closely engaged with the base, which may vary from ball head to ball head depending on the particular tolerances. In this manner, the pan base 114 may be accurately adjusted for even and accurate rotation. The body 100 includes an odd number of ½ notches while the outer ring 258 includes an even number of ½ notches, and after approximate alignment of the outer ring 258 to a suitable depth, the pin 260 is inserted into an aligned pair of ½ openings, thereby preventing further rotation. The inner ring 262 is threaded into the pan base 114 and thus rotates together with the pan base 114. The clamp 264, tightened together by operation of the pan knob 108 to inhibit rotation of the inner ring 262 which thus inhibits rotation of the pan base 114.

The engagement of the clamp 264 with the pan base inner ring 262 is along a surface, preferably at least 30% or more, more preferably 50% or more, more preferably 75% or more, and more preferably 90% or more, of the circumference of said inner ring 262. In this manner there is a significant amount of surface-to-surface contact, which results in a significant amount of potential friction, even in the case of some dirt and other debris becoming lodged on the surfaces thereof.

Referring again to FIG. 11, the bearing 202 includes a central region 280 that is ‘cut away’ from a matching surface with the ball 102 when engaged therewith. With a central region 280 not being in tight contact with the ball 102 when the clamp is not tightened the ball 102 is more freely movable. When the bearing 202 is squeezed against the ball 102 as a result of tightening the ball knob 108 and/or friction knob 110, the bearing 202 is deformed slightly normally in an elliptical fashion. The general result is contact in four primary regions of the ball 102, namely, a first lower portion of the ball, a first higher portion of the ball directly above the first lower portion, a second lower portion opposing the first lower portion of the ball, and a second higher location of the ball directly above the second lower portion opposing the first higher portion of the ball. The effect is to increase the effective overall surface area in contact between the bearing 202 and the ball 102, over what would occur if the central region 280 was not otherwise removed or thinned.

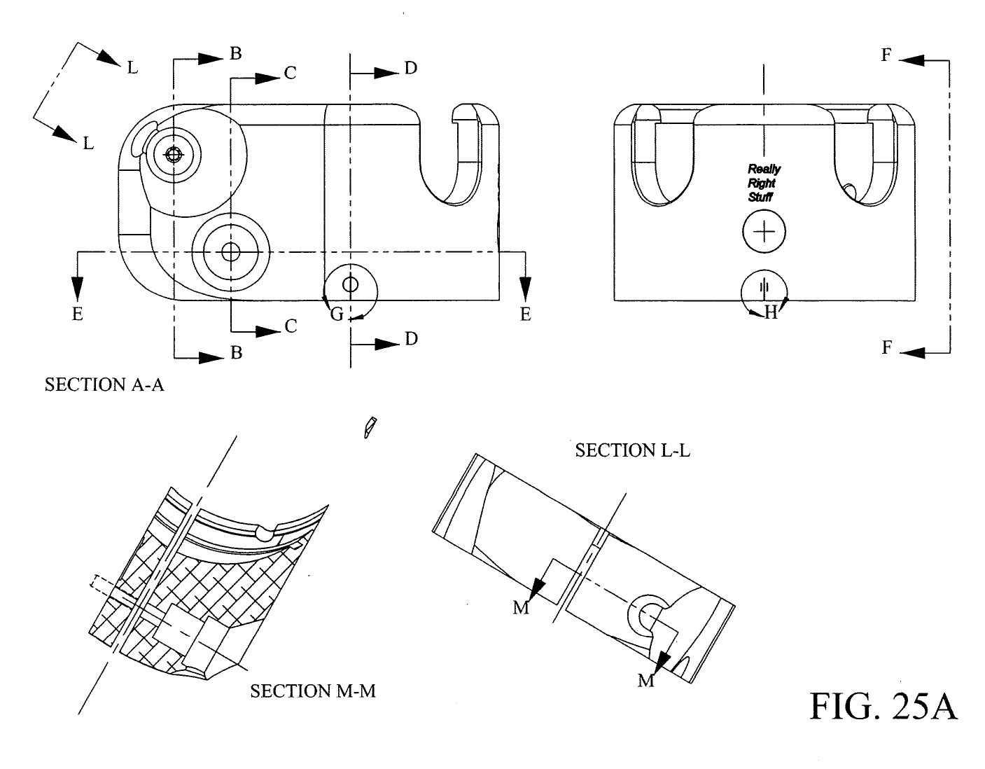

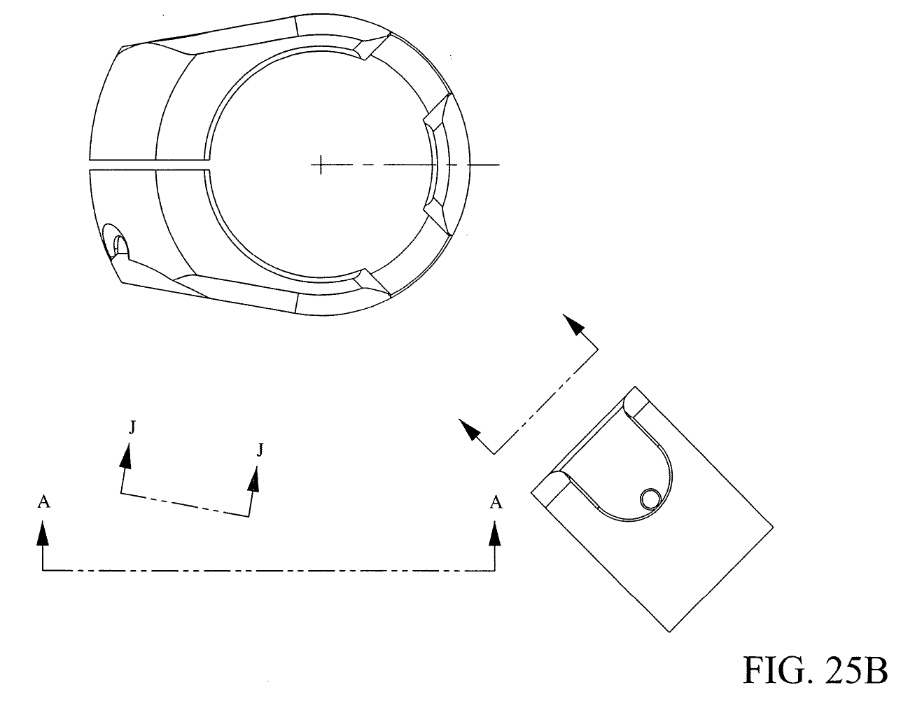

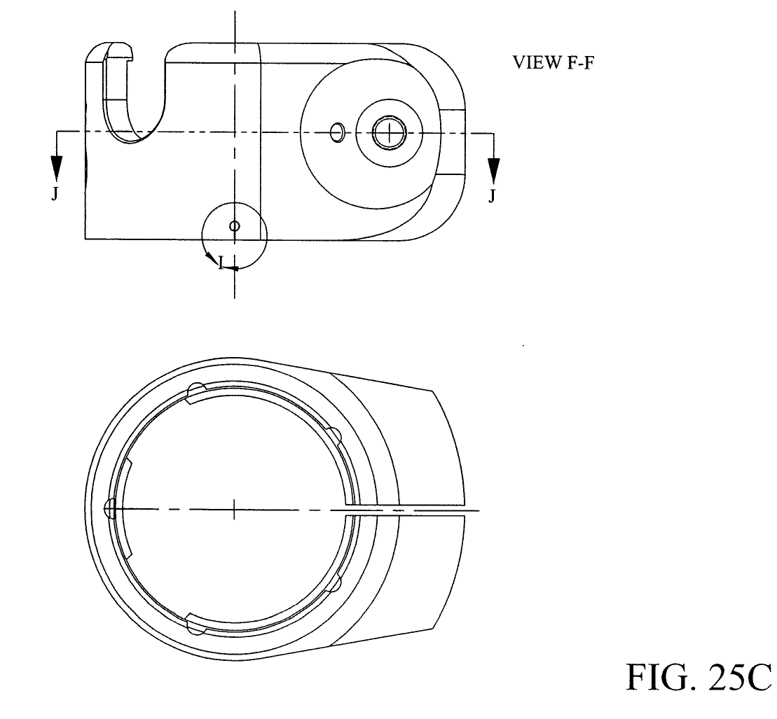

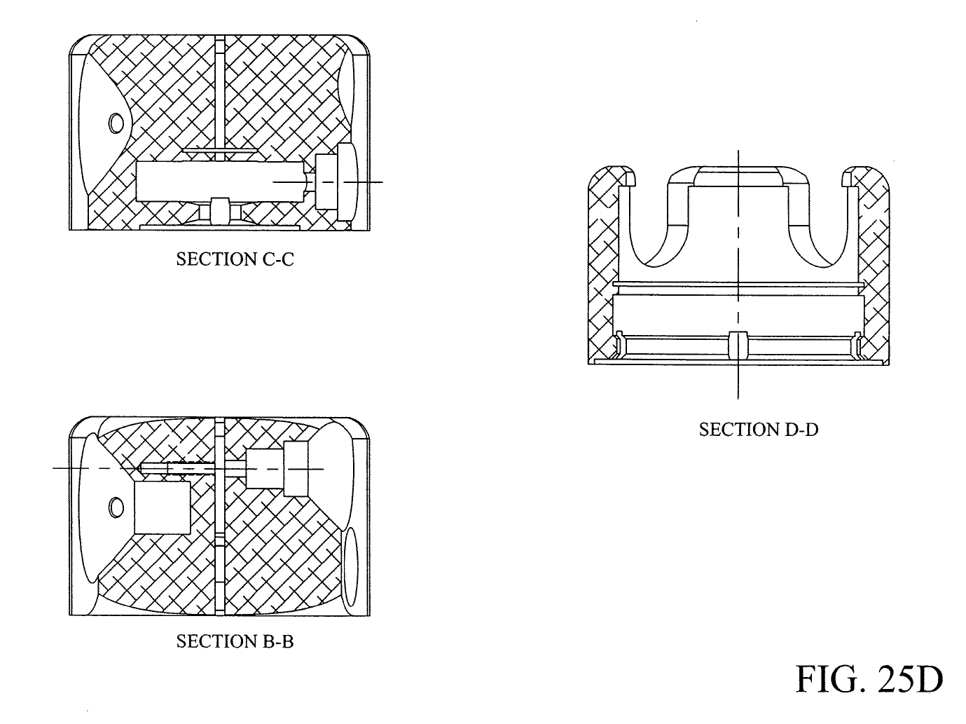

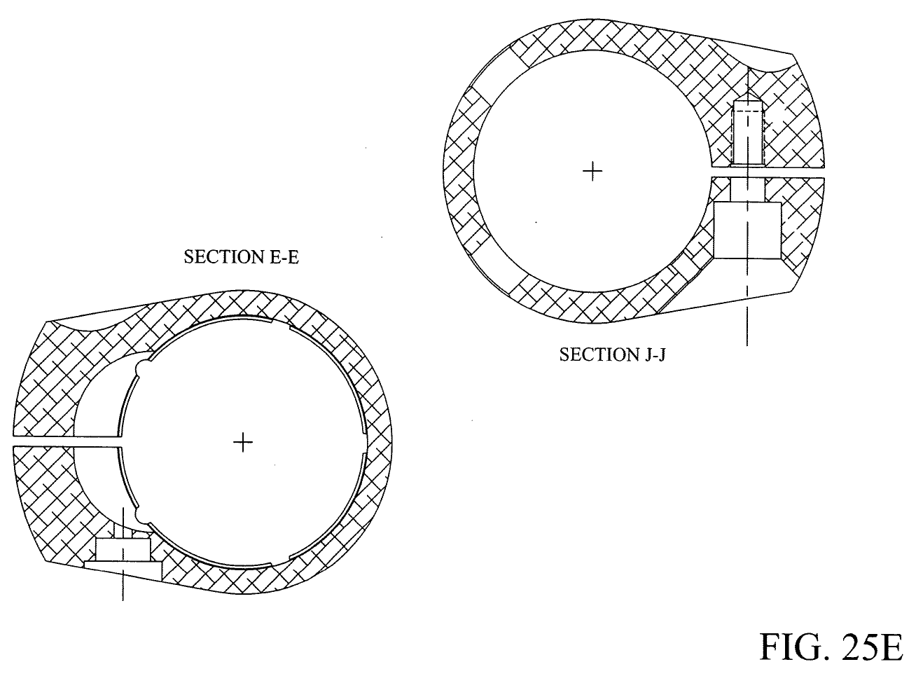

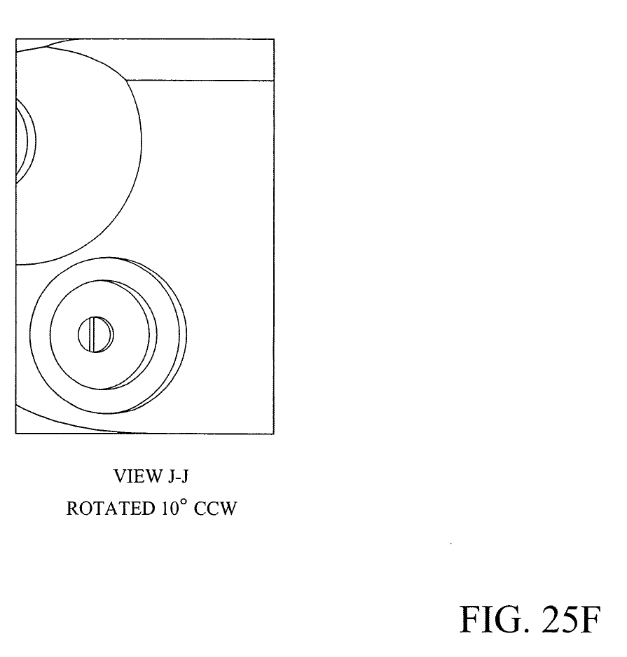

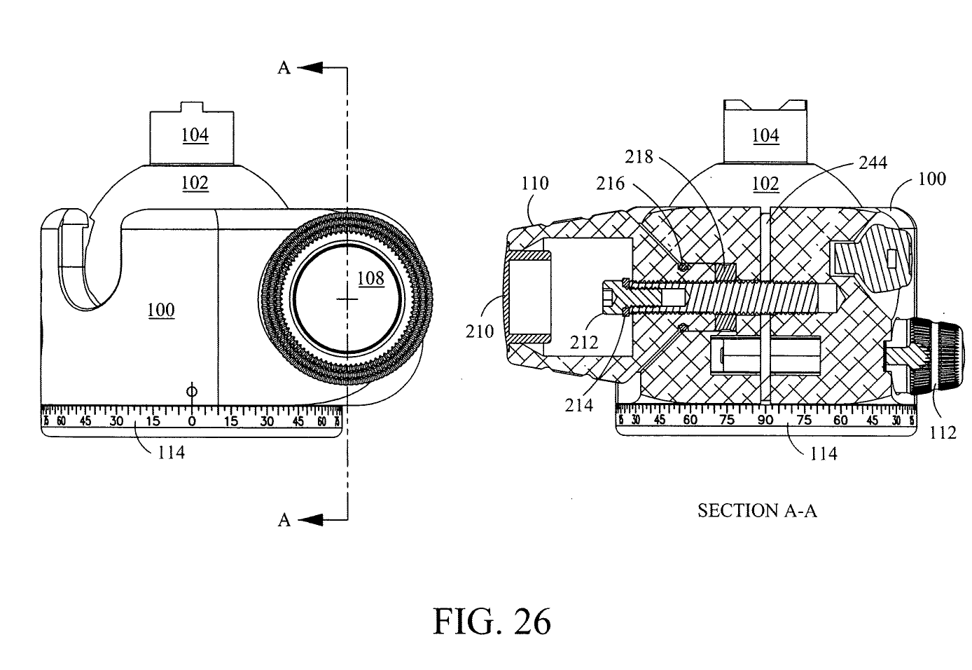

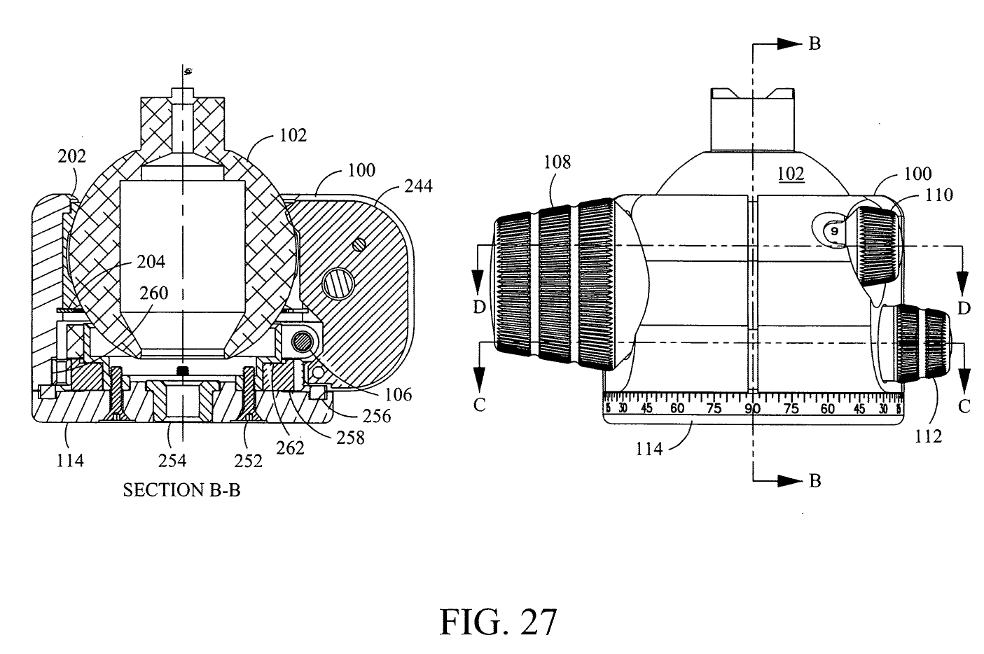

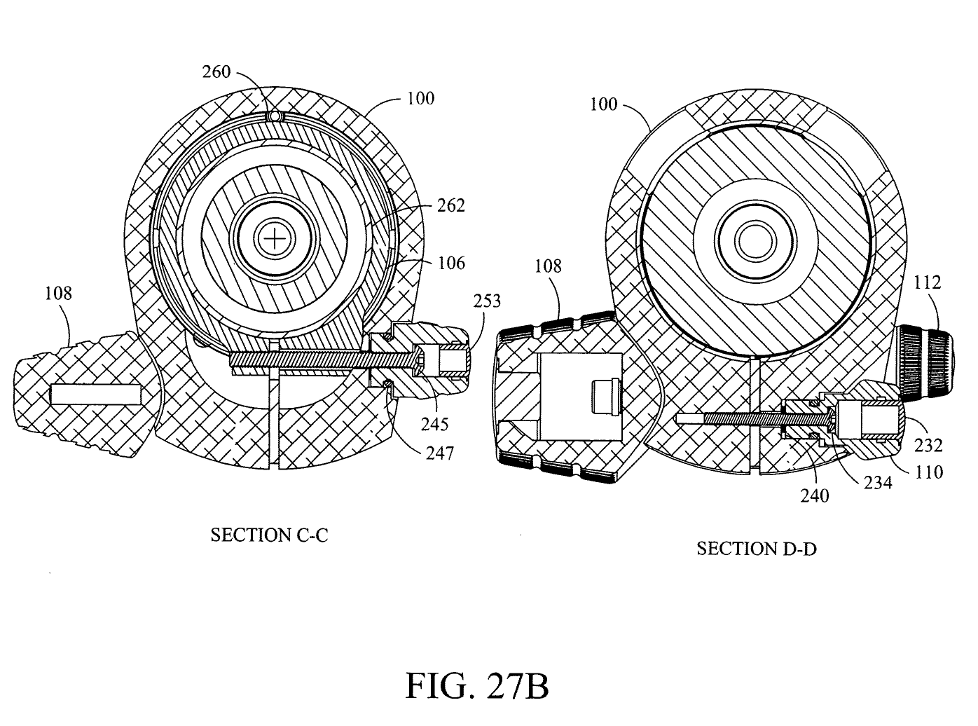

Referring to FIG. 25A-25F, a more detailed illustration of the preferred body 100 is illustrated. FIGS. 26 and 27 illustrates the knob mechanisms and the assembly of the tripod ball head.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A tripod head comprising:
(a) a rotatable ball contained within a body defining a socket;
(b) a first knob that selectively increases and decreases the ability of said ball to freely said rotate;
(c) a second knob that selectively increases and decreases the ability of said ball to freely rotate;
(d) wherein at least one of said first knob and said second knob is at least partially recessed within said body in such a manner that a flexible rod having a diameter of at least ¼ inch dragged across the exterior of said body in a region proximate said at least one of said knobs and subsequently dragged across the exterior of said at least one of said knobs in a horizontally circular direction is free from being moved backwards in order to pass said at least one of said knobs.

2. The tripod head of claim 1 wherein said at least one of said first knob and said second knob includes both said first and second knobs.

3. A tripod head comprising:
(a) rotatable ball contained within a body defining a socket;
(b) a first knob that selectively increases and decreases the ability of said ball to freely said rotate;
(c) wherein said first knob is at least partially recessed within said body in such a manner that a flexible rod having a diameter of at least ¼ inch dragged across the exterior of said body in a region proximate said first knob and subsequently dragged across the exterior of said first knob in a horizontally circular direction is free from being moved backwards in order to pass said first knob.

4. A tripod head comprising:
(a) a rotatable ball contained within a body defining a socket;
(b) a first knob that selectively increases and decreases the ability of said ball to freely said rotate;
(c) a shaft mechanically coupled to said first knob wherein at least a portion of said shaft is located at least partially within said body;
(d) a plurality of numbers written on said shaft indicating a measure of inhibiting said ball from freely rotating;
(e) wherein said numbers are at least partially located within an opening in said body.

5. A tripod head comprising:
(a) a rotatable ball contained within a body defining a socket;
(b) an extension from said rotatable ball for supporting an optical device thereon;
(c) said body defining a first drop notch such that said optical device may rotate at least 90 degree from a horizontal orientation;
(d) said body defining a second drop notch such that said optical device may rotate at least 90 degrees from a horizontal orientation;
(e) said first drop notch and said second drop notch being at an angle of substantially 90 degrees apart from one another.

6. The tripod head of claim 5 wherein said first and second drop notches are between 80 and 110 degrees apart from one another.

7. The tripod head of claim 6 wherein said first and second drop notches are 90 degrees apart from one another.

8. A tripod head comprising:
(a) a rotatable ball contained within a body having a height and defining a socket;
(b) a first knob that selectively increases and decreases the ability of said ball to freely said rotate;
(c) said first knob having a diameter at its base adjacent said body that is greater than 75% of the said height of said body.

9. A tripod head comprising:
(a) a rotatable ball contained within a body defining a socket;
(b) a first knob that selectively increases and decreases the ability of said ball to freely said rotate;
(c) said first knob having a maximum range of rotation from fully disengaged to fully engaged being less than 360 degrees of rotation.

10. A tripod head comprising:
(a) a rotatable ball contained within a body defining a socket;
(b) a first knob having an axis of rotation that selectively increases and decreases the ability of said ball to freely said rotate;
(c) said body being rotatable upon a base, wherein said base has an outer circumference;
(d) wherein said axis of said first knob is exterior to the outer circumference of said base.

11. A tripod head comprising:
(a) a rotatable ball contained within a body defining a socket;
(b) a first knob that selectively increases and decreases the ability of said ball to freely said rotate;
(c) second knob that selectively increases and decreases the ability of said ball to freely rotate;
(d) third knob that selectively inhibits the ability of said body to rotate on a base;
(e) wherein said first knob has an axis, wherein said second knob has an axis, wherein said third knob has an axis;
(f) wherein said axis of said first knob is within 30 degrees of said axis of said second knob and said axis of said third knob.

12. The tripod head of claim 11 wherein said axis of said second knob and said axis of said third knob are within 30 degrees of one another.

13. The tripod head of claim 12 wherein said axis of said second knob and said axis of said third knob are parallel to one another.

14. A tripod head comprising:
(a) a rotatable ball contained within a body defining a socket;
(b) a base where said body is rotatably engaged with said base;
(c) a first mechanism that selectively increases and decreases the ability of said ball to freely said rotate;
(d) wherein said base has an adjustment mechanism to modify the spacing between the base of said body and said base.

15. The tripod head of claim 14 wherein said first mechanism includes a surface-to-surface contact of at least 108 degrees.

16. The tripod of claim 15 wherein said contact is at least 180 degrees.

17. The tripod of claim 16 wherein said contact is at least 270 degrees.

18. The tripod of claim 17 wherein said contact is at least 324 degrees.

19. A tripod head comprising:
(a) a rotatable ball contained within a body defining a socket;
(b) a mechanism that selectively increases and decreases the ability of said ball to said rotate;
(c) wherein inhibiting the ability of said ball to rotate results in a upper and a lower portion of said ball to include a pressure greater than the region between said upper and lower portion of said ball.

20. The tripod head of claim 19 wherein a bearing is located within said socket.

21. The tripod head of claim 20 wherein said bearing has a central region that is thinner than another portion of said bearing.
